(19) United States
(12) Patent Application Publication
(10) Pub. No.: US 2024/0100976 A1
(43) Pub. Date: Mar. 28, 2024

(54) Systems and Methods for Charging the Battery of an Electric Vehicle

(71) Applicant: NXU Technologies, LLC, Tempe, AZ (US)

(72) Inventors: Victor Atlasman, Mesa, AZ (US); Rosten Sweeting, Mesa, AZ (US); Levi Clayton, Mesa, AZ (US)

(73) Assignee: NXU Technologies, LLC, Tempe, AZ (US)

(21) Appl. No.: 18/530,701

(22) Filed: Dec. 6, 2023

Related U.S. Application Data
(60) Provisional application No. 63/430,390, filed on Dec. 6, 2022.

(51) Int. Cl. B60L 53/18; B60L 53/302; B60L 53/62

(52) U.S. Cl. CPC B60L 53/18; B60L 53/302; B60L 53/62

(57) ABSTRACT

A system and method for charging a battery of an electric vehicle. The method includes removing a coolant from the electrical cable that provides energy to the electric vehicle prior to handling of the electrical cable by a user. Removing the coolant from the electrical cable decreases a weight of the cable and increases the flexibility of the cable thereby enabling the user to more easily manipulate the electrical cable to connect the electrical cable to and disconnect the electrical cable from the electric vehicle.

### BACKGROUND

Embodiments of the present invention relate to a charger for charging the battery of an electric vehicle.

A battery stores electrical energy that may be provided to an electric vehicle (also referred to as a Battery Electric Vehicle or EV) to operate the electric vehicle. The battery must be recharged from time to time for continued operation of the electric vehicle. A charger (also referred to as electric vehicle service equipment) is used to provide energy to the battery of the electric vehicle. The charger includes, inter alia, a power supply and an electrical cable. The electrical cable carries energy from a power supply (e.g., line power) to the electric vehicle. A coolant may be used to cool the electrical cable during use; however, the coolant can make the electrical cable heavy and difficult for a user to lift or move. Users may benefit from a charger that removes the coolant from the electrical cable while it is being manipulated by a user.

### SUMMARY

A charger is used to provide energy to a battery of an electric vehicle to recharge the battery. An electrical cable extends from the charger to the electric vehicle. The electrical cable provides the energy from the charger to the battery. The current carried by the electrical cable can be very high to decrease the amount of time required to recharge the battery. The high current can increase the temperature of the conductors in the electrical cable. If the current is high enough, the heat caused by the current flow could damage the conductors.

The conductors of the electrical cable may be cooled so that the conductors may carry the high current without damage. In an example embodiment, a liquid is used as a coolant to cool the conductors. The liquid circulates around the conductors to extract heat from the conductors to cool the conductors. In another example embodiment, the coolant (e.g., medium) changes phase from a liquid to a gas to cool the conductors. The change in phase of the cooling medium extract heat from the conductors. In either embodiment, the coolant fills and/or circulates through channels that surround the conductors of the electrical cable. A pump circulates the coolant through the channels. The presence of the coolant in the channels of the electrical cable increases the weight of the electrical cable thereby making it more difficult for a user to lift the electrical cable to extend it from the charger to the electric vehicle prior to charging the battery. Further, pressurizing the coolant in the channels of the electrical cable reduces the flexibility of the cable which also makes the electrical cable more difficult for the user to manipulate (e.g., handled, moved, lifted).

In an example embodiment, the charger cooperates with the electric vehicle to determine when the electrical cable is in use to deliver energy to the electric vehicle. When the electrical cable is not in use, the charger evacuates (e.g., removes) the coolant from the electrical cable. Before the electrical cable delivers energy, the charger fills and/or circulates coolant through the electrical cable. The user does not manipulate the electrical cable while it delivers energy to the electric vehicle, so during the time that the electrical cable is manipulated by the user, the coolant has been evacuated from the electrical cable thereby decreasing the weight of electrical cable and increasing its flexibility.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a diagram of an example embodiment of a charger according to various aspects of the present disclosure.

FIG. 2 is a diagram of the charger of FIG. 1 connected to an electric vehicle by the electrical cable.

FIG. 3 is a cross-section diagram of an example embodiment of an electrical cable.

FIG. 4 is a cross-section diagram along a length of the example embodiment of the electrical cable of FIG. 3.

FIG. 5 is diagram of another example embodiment of a handle and another example embodiment of an electrical cable.

FIG. 6 is a cross-section diagram of the second example embodiment of the electrical cable of FIG. 5.

FIG. 7 is a diagram of an example embodiment of the charger of FIG. 1.

FIGS. 8A and 8B are flow diagrams of an example method for charging an electric vehicle using an electrical cable that is cooled using a liquid coolant.

FIGS. 9A and 9B are a flow diagram of an example method for charging an electric vehicle using an electrical cable that is cooled using a phase-change coolant.

FIG. 10 is a diagram of an example embodiment of an electric vehicle system for charging the battery of the electric vehicle.

FIG. 11 is a diagram of another example embodiment of an electrical cable.

FIG. 12 is a cross-section diagram along a length of the example embodiment of the electrical cable of FIG. 11.

FIG. 13 is a cross-section diagram along a length of the example embodiment of the electrical cable of FIG. 11 while evacuating the coolant from the electrical cable.

### DETAILED DESCRIPTION

### Overview

In an example embodiment, charger 100 delivers energy to electric vehicle 200 to charge battery 240. Prior to delivering energy to electric vehicle 200, handle 130/530 is inserted into receptacle 120 of the charger 100 and no current flows through electrical cable 140/540. Further, there is no coolant in the channels (e.g., 330, 340, 512, 522, 552, 562, 1110) of the electrical cable 140/540 because there is no need to cool the conductors (e.g., 310, 320, 510, 520, 550, 560) because no current flows through them.

When the user 230 determines that it is time to charge the battery 240, the user 230 positions the electric vehicle 200 proximate to the charger 100. The user 230 removes the handle 130/530 from the receptacle 120, stretches the electrical cable 140/540 from the charger 100 towards the electric vehicle 200 and inserts the handle 130/530 into the receptacle 220 of the electric vehicle 200. The electrical cable 140/540 extends from the charger 100 to the electric vehicle 200. While the user moves the handle 130/530 from the receptacle 120 to the receptacle 220, no current flows through the electrical cable 140/540. Further, there is no coolant in the channels (e.g., 330, 340, 512, 522, 552, 562, 1110) of electrical cable 140/540.

Once the handle 130 is connected to the receptacle 220 of the electric vehicle 200, energy may be delivered from the charger 100 to the battery 240 via the conductors (e.g., 310, 320, 510, 520, 550, 560) of the electrical cable 140/540. As the current flows through the conductors, the temperature of the conductors increases. To protect the conductors from damage, prior to starting the current flow, the coolant pump 740 pumps a coolant into the channels (e.g., 330, 340, 512, 522, 552, 562, 1110) of the electrical cable 140/540. The coolant cools the conductors to maintain the temperature of the conductors at a temperature or in a range of temperatures that does not damage the conductors. The coolant pump 740 circulates the coolant through the channels before, while and/or after electrical energy in the form of an electrical current is provided to the electric vehicle 200 to charge the battery 240.

After the battery 240 has been charged, the charger 100 ceases to deliver energy to the battery 240 via the electrical cable 140/540. Once the current flowing through the conductors (e.g., 330, 340, 512, 522, 552, 562, 1110) is reduced to a threshold amount, or zero, the coolant pump 740 pumps the coolant out of the channels thereby evacuating the channels, so that they hold little or no coolant. The evacuated channels may contain a gas whether air or the coolant in gas form. Once the channels have been evacuated, the charger 100 and/or the electric vehicle 200 informs the user 230 that the user 230 may remove the handle 130/530 from the receptacle 220. The user 230 removes the handle 130/530 from the receptacle 220, moves the handle 130/530 and the electrical cable 140/540 toward the charger 100 and inserts the handle 130/540 into the receptacle 120.

Because the coolant is present in the channels (e.g., 330, 340, 512, 522, 552, 562, 1110) only while, or for a time after, the current flows through the conductors (e.g., 310, 320, 510, 520, 550, 560), each time the user 230 manipulates (handles, moves, left) e.g., the handle 130/530 and the electrical cable 140/540, there is little or no liquid coolant in the channels thereby reducing the weight of the electrical cable 140/540 and increasing its flexibility to ease handling by the user 230.

### Charger

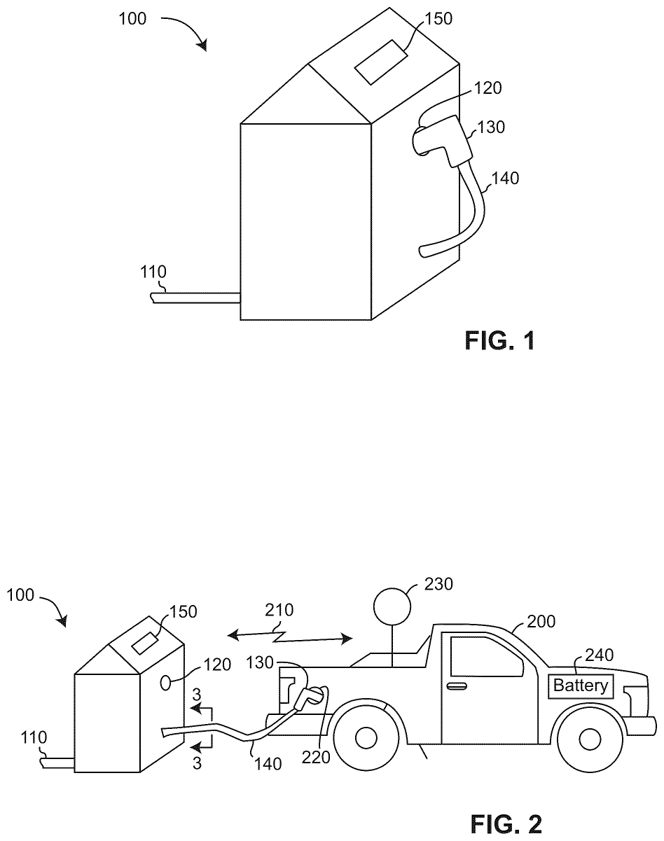

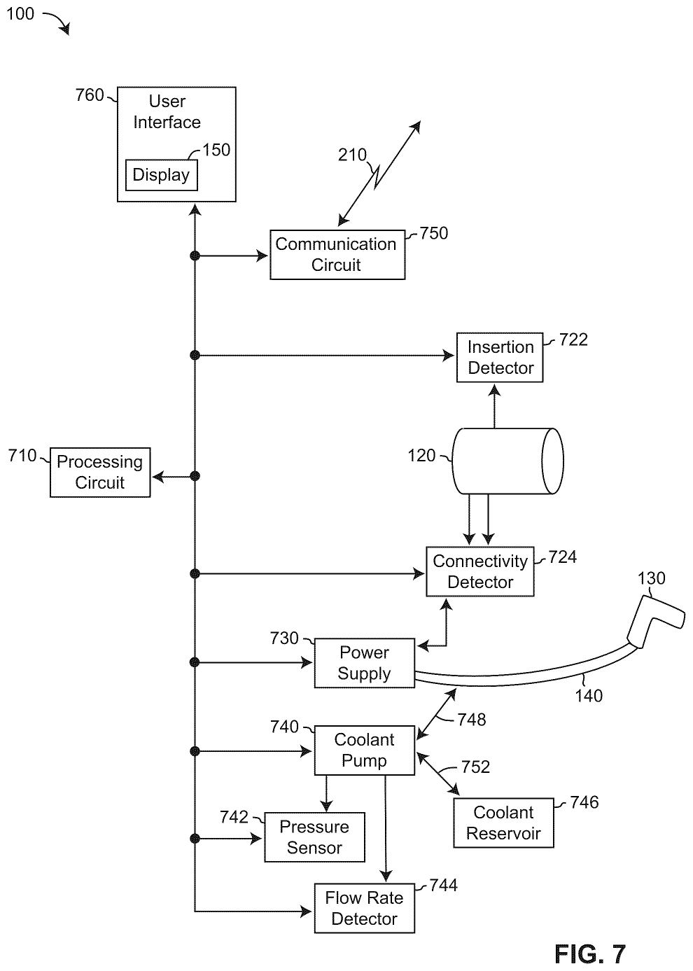

The charger 100, as best shown in FIGS. 1-2 and 7, delivers energy to the electric vehicle 200 to recharge the battery 240. The charger 100 includes the receptacle 120, the handle 130 or the handle 530, the electrical cable 140 or the electrical cable 540 and the display 150. The user 230 manipulates the handle 130/530 and the electrical cable 140/540 to electrically and mechanically connect the charger 100 to the electric vehicle 200. As discussed above, the electrical cable 140/540 weighs less and is more flexible when the channels 330 and 340 or 512, 522, 552 and 562 and 1110 do not hold coolant or the coolant is in the form of a gas at little or no pressure. According to various aspects of the present disclosure, the charger 100 evacuates the liquid coolant from the channels or decreases the pressure of a gaseous coolant at the times when the user 230 must manipulate the handle 130/530 and the electrical cable 140/540.

The user provides information to and receives information from the charger 100 via the display 150. In another example embodiment, the user 230 communicates with the charger 100 via an electronic device and a wireless communication link 210. The display 150 may include controls (e.g., buttons, touchscreen) for the user 230 to operate to provide information to the charger 100. The charger 100 may provide information to the user 230 by presenting the information on the display 150. The charger 100 may inform the user 230 when charging is complete and when the handle 130 may be removed from the receptacle 220. The processing circuit 710 may control the coolant pump 740 so that when charging is complete or almost complete, the coolant pump 740 pumps most if not all of the liquid coolant out of the channels (e.g., 330, 340, 512, 522, 552, 562, 1110) back into the coolant reservoir 746 to reduce the weight and to increase the flexibility of the electrical cable 140/540.

The charger 100 further includes processing circuit 710, insertion detector 722, connectivity detector 724, power supply 730, coolant pump 740, pressure sensor 742, flow rate detector 744, coolant reservoir 746, communication circuit 750 and user interface 760. The processing circuit 710 may control some or all of the components of the charger 100 partially or completely. The processing circuit 710 is configured to execute a stored program to perform its functions, which thereby performs the functions of the charger 100.

The communication circuit 750 communicates (e.g., transmits, receives) via wireless communication link 210. The communication circuit 1050 of the electric vehicle 200 may communicate with the communication circuit 750 via the communication link 210. The communication circuit 750 may communicate with an electronic device (e.g., tablet, smart phone) via wireless communication link 210. In an example embodiment, the processing circuit 710 is configured to provide information to the communication circuit 750 for transmission. The communication circuit 750 is configured to receive information via the communication link 210 and to provide the information to the processing circuit 710.

The user interface 760 includes the display 150, which, as discussed above, presents information to and may receive information from (e.g., touchscreen) the user 230. The power supply 730 receives power from power source 110 (e.g., electric utility, generator, source of renewable energy). The coolant pump 740 circulates coolant from the coolant reservoir 746 through the electric cable 140/540 to cool the conductors (e.g., 310, 320, 510, 520, 550, 560). Pressure sensor 742 detects the pressure of the coolant in the channels (e.g., passages, voids) of the electrical cable 140/540. The flow rate detector 744 detects the rate of flow of the coolant through the electrical cable 140/540.

The processing circuit 710 may control the power supply 730 to start and stop energy delivery to the electric vehicle 200. The processing circuit 710 may provide information to the user 230 via the display 150 with respect to the status (e.g., stage, state, progress) of the charging process. The processing circuit 710 may monitor and control the rate of energy delivery to the electric vehicle 200. The processing circuit 710 may monitor the temperature of the conductors (e.g., 310, 320, 510, 520, 550, 560). The processing circuit may increase or decrease the rate of energy delivery in accordance with the temperature of the conductors 310 and 320. The processing circuit may increase or decrease the rate of coolant flow and/or pressure in accordance with the temperature of the conductors. The processing circuit 710 may receive information from the coolant pump 740, the pressure sensor 742 and/or the flow rate detector 744. The processing circuit 710 may control the coolant pump 740 in accordance with the temperature of the conductors and/or the information from the coolant pump 740, the pressure sensor 742 and/or the flow rate detector 744.

In an example embodiment, the processing circuit 710 is configured to instruct the coolant pump to increase the pressure and/or the flow rate of the coolant through the channels (e.g., 330, 340, 512, 522, 552, 562, 1110) to decrease the temperature of the conductors (e.g., 310, 320, 510, 520, 550, 560). As the temperature of the conductors decreases, the processing circuit is configured to control the power supply 730 to increase the rate of delivery to the electric vehicle 200. The processing circuit 710 may balance the rate of delivery of energy, the pressure and/or flow rate of the coolant in the channels and the temperature of the conductors to decrease an amount of time needed to recharge the battery 240.

The insertion detector 722 is configured to detect the physical presence of the handle 130/530 in the receptacle 120. While the handle 130/530 is inserted into the receptacle 120, the handle 130/530 and the conductors (e.g., 310, 320, 510, 520, 550, 560) may be electrically connected to the connectivity detector 724. The connectivity detector 724 may report data to the processing circuit 710. The connectivity detector 724 may electrically connect the conductors 310 and 322 the power supply 730 while the handle 130/530 is inserted into the receptacle 120. The handle 130/530 and the conductors may electrically connect to the power supply 730 for testing purposes and/or to short out (e.g., ground) the conductors when not in use to protect the user 230 from any potential electric shock.

### Electric Vehicle Charging System

In an example embodiment, the electric vehicle 200 includes the charging system 1000. In an example embodiment, a charging system 1000 includes receptacle 220, processing circuit 1010, insertion detector 1022, connectivity detector 1024, communication circuit 1040 and user interface 1560. The processing circuit 1010 controls some or all of the components of the charging system 1000 completely or partially. The insertion detector 1022 detects the physical presence of the handle 130/530 in the receptacle 220. Insertion detector 1022 may further include a lock that locks (e.g., holds, affixes) the handle 130/530 in the receptacle 220 during the charging process. Locking the handle 130/530 in the receptacle 220 prohibits the user 230 from removing the handle 130/530 from the receptacle 220 during the charging process and in particular while high currents flow from the charger 100 to the electric vehicle 200. The lock may further fix the position of the handle 130/530 with respect to the receptacle 220 to maintain an electrical connection between the handle 130/530 and the conductors (e.g., 310, 320, 510, 520, 550, 560) with the electric vehicle 200.

The connectivity detector 1024 is configured to detect whether the handle 130/530 and thereby the conductors (e.g., 310, 320, 510, 520, 550, 560) are electrically connected to the electric vehicle charging system 1000 and thereby to the battery 240. Energy cannot be delivered from the charger 100 to the battery 240 unless there is an electrical connection between the charger 100 and the electric vehicle charging system 1000. In an example embodiment, the connectivity detector 1024 is configured to determine when the handle 130/530 and thereby the conductors (e.g., 310, 320, 510, 520, 550, 560) are electrically connected to the charging system 1000. In one embodiment, the connectivity detector 1024 detects that the handle 130/530 is electrically connected to the electric vehicle charging system 1000. The connectivity detector 1024 reports the connection to the charger 100 via the electrical cable 140/540. In another embodiment, the connectivity detector 1024 reports the status of the connection to the processing circuit 1010. The processing circuit 1010 transmits the status of the connection to the processing circuit 710 via the communication link 210. The processing circuit 1010 may report when the handle 130/530 is electrically connected to the electric vehicle charging system 1000 and when the handle 130/530 is not electrically connected to the electric vehicle charging system 1000.

The processing circuit 710 may receive the status of the connection between the handle 130/530 and the electric vehicle charging system 1000 from the processing circuit 1010 via the communication circuit 1050, the communication link 210 and the communication circuit 750. The processing circuit 710 may use the information regarding the status of the connection to provide coolant to or evacuate coolant from the channels (e.g., 330, 340, 512, 522, 552, 562, 1110) of the electrical cable 140/540. In an example embodiment, the processing circuit 710 controls the coolant pump 740 to provide coolant to the electrical cable 140/540 only while the handle 130/530 is inserted into and electrically connected to the electric vehicle charging system 1000. Once the battery 240 has been charged, but prior to permitting the user 230 to remove the handle 130/530 from the receptacle 220, the processing circuit 710 may instruct the coolant pump 740 to evacuate the channels of most or all of the liquid coolant and/or reduce the pressure of the gas in the channels.

Once the coolant has been evacuated and/or the pressure reduced, the processing circuit 710 may inform the user via display 150 that the handle 130/530 may be removed from the receptacle 220. The processing circuit 710 may also inform the user 230 that the handle 130/530 may be removed from the receptacle 220 by transmitting a message to the processing circuit 1010 via the communication circuit 750, the communication link 210 and the communication circuit 1050 to the processing circuit 1010. The processing circuit 1010 may inform the user via the display 1062 that the handle 130/530 may be removed from the receptacle 220.

### Electrical Cable—First Embodiment

In a first example embodiment of an electrical cable, the electrical cable 140 includes the conductor 310, the conductor 320, the channel 330, the channel 340 and housing (e.g., case, receptacle, sheath) 350. The housing 350 is formed of an insulator (e.g., electrically insulating) material. Housing 350 encases (e.g., encloses, encircles) the conductors 310 and 320 and forms the channels 330 and 340. The inside diameters of the channels 330 and 340 are greater than the outer (e.g., outside) diameter of the conductors 310 and 320 respectively thereby leaving room for a coolant to flow around the conductors 310 and 320. The housing 350 separates the conductors 310 and 320 mechanically and electrically. The housing 350 protects the user 230 from forming an electric circuit with the conductor 310 and/or the conductor 320 thereby protecting the user 230 from electrical shock. The channels 330 and 340, as discussed above, may hold a coolant (e.g., a flow of coolant). The coolant comes into physical contact with the conductors 310 and 320. The coolant transfers heat from the conductors 310 and 320 into the coolant. In an example embodiment, the coolant is a liquid. The liquid coolant circulates through the channels 330, 340 and 410. Heat is transferred from the conductors 310 and 320 into the liquid. Heat is carried away from the conductors 310 and 320 by the circulating liquid coolant. Heat is removed from the liquid coolant by the coolant pump 740, or a separate refrigeration unit that is part of the circulation loop, thereby removing heat from the conductors 310 and 320. In this example embodiment, the coolant remains a liquid as it receives, transfers and loses heat.

In another example embodiment, the coolant is a liquid that changes phase to remove heat from the conductors 310 and 320. In this embodiment, the coolant pump 740 pumps a liquid into the channels 330 and 340 and removes a gas to remove heat from the conductors 310 and 320. The coolant pump 740 removes energy from the gas thereby allowing the gas to become a liquid. In this example embodiment, a portion of the channels 330, 340 and 410 may contain or transport the coolant in its liquid form, while the remaining portion of the channels contains the coolant in its gaseous form.

The coolant pump 740 controls the amount of coolant present in the channels 330 and 340. As the amount of coolant in the channels 330 and 340 increases, the weight of the electrical cable 140 increases. As the amount of coolant in the channels 330 and 340 decreases, the weight of the electrical cable 140 decreases. The flexibility of the electrical cable 140 is also inversely proportional to the amount of coolant present in the channels 330 and 340 and the pressure of the coolant.

The processing circuit 710 is further configured to control the coolant pump 740 to evacuate coolant from the channels 330 and 340 prior to manipulation of the electrical cable 140 by the user 230. The processing circuit 710 may also control the coolant pump 740 to decrease the pressure of the coolant in the channels 330 and 340 prior to manipulation of the electrical cable 140 by the user 230. Reducing the amount and/or the pressure of the coolant in the channels 330 and 340 decreases the weight and increases the flexibility of electrical cable 140 to allow the user 230 to more easily lift and move the handle 130 and the electrical cable 140.

In this example embodiment, the coolant pump 740 pumps a coolant into channel 330, which may be referred to as the inlet channel 330. The coolant pumped into the inlet channel 330 circulates through the inlet channel 330 as inward coolant flow 430. Somewhere in the handle, the connecting channel 410 connects the inlet channel 330 to the channel 340, which may be referred to as the outlet channel 340. The coolant pump 740 continues to pump coolant into the inlet channel 330 thereby resulting in inward current flow 430, connecting coolant flow 412 and outward coolant flow 440. The pump provides inward coolant flow 430 into the inlet channel 330 and receives the outward coolant flow 440 from the outlet channel 340. As the coolant circulates through the inlet channel 340, the connecting channel 410 and the outlet channel 340, the coolant extracts heat from the conductors 310 and 320 and delivers that heat in the form of the heated coolant to coolant pump 740 via flow 748. Coolant reservoir 746 provides coolant to and receive coolant from the coolant pump via flow 752.

The coolant pump 740, in combination with the processing circuit 710, is configured to set the pressure of the coolant that flows through the channels 330, 410 and 340. Pressure sensor 742 detects the pressure of the coolant exiting and/or entering the coolant pump 740. Pressure sensors may be positioned along a length of the electrical cable 140/540 to enable the pressure sensor 742 to detect the pressure of the coolant at any position along the electrical cable 140/540. The processing circuit 710 may also be configured to calculate the pressure of the coolant inside the channels 330, 410 and 340 and along the length of the electrical cable 140/540 using the information provided by the pressure sensor 742.

The flow rate detector 744 detects the rate of flow of coolant into the inlet channel 340 and/or out of the outlet channel 340. The processing circuit 710 may also be configured to calculate the flow rate of the coolant inside the channels 330, 410 and 340 using the information provided by the flow rate detector 744.

### Electrical Cable—Second Embodiment

In a second example embodiment of an electrical cable, the electrical cable 540 includes the conductor 510, the conductor 520, the conductor 550, the conductor 560, the channel 512, the channel 522, the channel 552, the channel 562 and the housing 640. The housing 640 is formed of an insulator material. Housing 640 encases the conductors 510, 520, 550 and 560 and forms the channels 512, 522, 552 and 562. The inside diameters of the channels 512, 522, 552 and 562 are greater than the outer (e.g., outside) diameter of the conductors 510, 520, 550 and 560 respectively thereby leaving room for the coolant to flow around the conductors 510, 520, 550 and 560. The channels 512, 522, 552 and 562 may combine with each other in any manner to permit the flow of coolant through the channels. Any number of channels may function as inlet channels while any number of other channels may function as outlet channels.

The housing 640 separates the conductors 510, 520, 550 and 560 mechanically and electrically. The housing 640 protects the user 230 from forming an electric circuit with the conductors 510, 520, 550 and/or 560 thereby protecting the user 230 from electrical shock. The channels 512, 522, 552 and 562, as discussed above, may hold a coolant (e.g., a flow of coolant). The coolant comes into physical contact with the conductors 510, 520, 550 and 560. The coolant transfers heat from the conductors 510, 520, 550 and 560 into the coolant. In an example embodiment, the coolant is a liquid. The liquid coolant circulates through the channels 512, 522, 552 and 562. Heat is transferred from the conductors 510, 520, 550 and 560 into the liquid. Heat is carried away from the conductors 510, 520, 550 and 560 by the circulating liquid coolant. Heat is removed from the liquid coolant by the coolant pump 740, or a separate refrigeration unit that is part of the circulation loop, thereby removing heat from the conductors 510, 520, 550 and 560. In this example embodiment, the coolant remains a liquid as it receives, transfers and loses heat.

In another example embodiment, the coolant is a liquid that changes phase to remove heat from the conductors 510, 520, 550 and 560. In this embodiment, the coolant pump 740 pumps a liquid into the channels 512, 522, 552 and 562 and removes a gas to remove heat from the conductors 510, 520, 550 and 560. The coolant pump 740 removes energy from the gas thereby allowing the gas to become a liquid. In this example embodiment, a portion of the channels 512, 522, 552 and 562 may contain or transport the coolant in its liquid form, while the remaining portion of the channels contains the coolant in its gaseous form.

The coolant pump 740 controls the amount of coolant present in the channels 512, 522, 552 and 562. As the amount of coolant in the channels 512, 522, 552 and 562 increases, the weight of the electrical cable 540 increases. As the amount of coolant in the channels 512, 522, 552 and 562 decreases, the weight of the electrical cable 540 decreases. The flexibility of the electrical cable 540 is also inversely proportional to the amount of coolant present in the channels 512, 522, 552 and 562 and/or the pressure thereof.

The processing circuit 710 further controls the coolant pump 740 to evacuate coolant from the channels 512, 522, 552 and 562 prior to manipulation of the electrical cable 540 by the user 230. The processing circuit 710 may also control the coolant pump 740 to decrease the pressure of the coolant in the channels 512, 522, 552 and 562 prior to manipulation of the electrical cable 540 by the user 230. Reducing the amount and/or the pressure of the coolant in the channels 512, 522, 552 and 562 decreases the weight and increases the flexibility of electrical cable 540 to allow the user 230 to more easily lift and move the handle 530 and the electrical cable 540.

In an example embodiment, the coolant pump 740 pumps a coolant into channels 512 and 522, which may be referred to as inlet channels 512 and 522. The coolant pumped into the inlet channels 512 and 52 circulates through the inlet channels 512 and 52 as an inward coolant flow. Somewhere in the handle, the channels 512, 522, 552 and 562 meet a common cavity. The inward coolant flow enters the cavity and exits into channels 552 and 562, which may be referred to as outlet channels 552 and 562. The coolant that flows through the outlet channels 552 and 562 maybe referred to as an outward coolant flow. The outward coolant flow travels the length of the outlet channels 552 and 562 to the coolant pump 740. The coolant pump 740 continues to pump coolant into the inlet channels 512 and 522 to circulate coolant through the channels 512, 522, 552 and 562. As the coolant circulates through the channels 512, 522, 552 and 562, the coolant extracts heat from the conductors 510, 520, 550 and 560 and delivers that heat in the form of the heated coolant to coolant pump 740 via flow 748. Coolant reservoir 746 provides coolant to and receive coolant from the coolant pump via flow 752.

The coolant pump 740, in combination with the processing circuit 710, sets the pressure of the coolant that flows through the channels 512, 522, 552 and 562. Pressure sensor 742 is configured to detect the pressure of the coolant exiting and/or entering the coolant pump 740. The processing circuit 710 may be configured to calculate the pressure of the coolant inside the channels 512, 522, 552 and 562 using the information provided by the pressure sensor 742.

The flow rate detector 744 detects the rate of flow of coolant into the inlet channels 512 and 522 and/or out of the outlet channels 552 and 562. The processing circuit 710 may be configured to calculate the flow rate of the coolant inside the channels 512, 522, 552 and 562 using the information provided by the flow rate detector 744.

### Spacers

In an example embodiment, an electrical cable includes two or more spacers (e.g., separators, castings) 360/660. A spacer 360/660 fixes (e.g., sets, establishes) a space between an outer surface of a conductor (e.g., 310, 320, 510, 520, 550, 560) and the inner surface of a channel (e.g., 330, 340, 512, 522, 552, 562). The spacer 360/660 establishes (e.g., fixes) a space between the outer surface of the conductor and inner surface of the channel to provide an area for the flow of coolant. The spacer 360/660 maintains the space between the outer surface of the conductor and the inner surface of the channel as the user 230 moves and manipulates the electrical cable 140/540. The spacers 360/660 maintain an open passage around and along a length of a conductor for the flow of coolant to contact and pass along the length of the conductor. In other words, the spacers keep the channel open for the flow of coolant on all sides around the conductor. The spacers 360/660 maintain the open passage along the length of the conductors regardless of the position of the electrical cable 140/540 with respect to the charger 100 and/or the electric vehicle 200. The spacers 360/660 maintain a minimum distance between the outer surface of the conductor and the inner surface of the channel. The minimum distance enables a minimum amount of coolant to surround the conductor along the length of the conductor. Cooling all sides of the conductor (e.g., entire diameter) with a minimum amount of coolant flow decreases hotspots along the conductor.

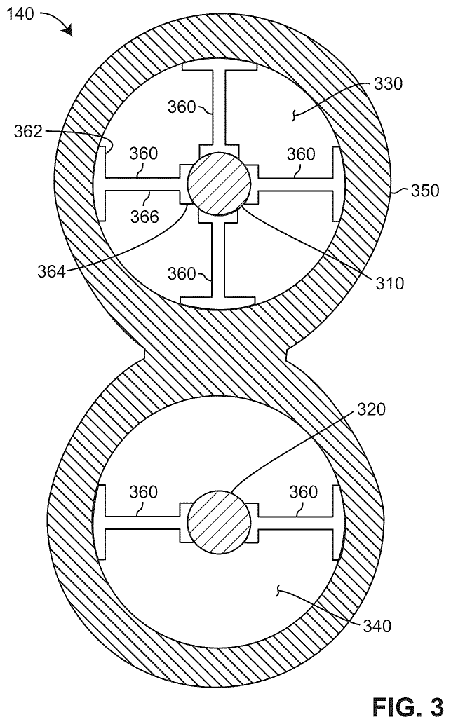

In an example embodiment, a spacer 360 includes a base 362, a stem 366 and a head 364. The base 362 is positioned against and/or embedded in an inner surface of the channel (e.g., channel 330 as shown in FIG. 3). The head 364 is positioned against and/or embedded in the conductor (e.g., conductor 310 as shown in FIG. 3). The stem 366 is positioned between the base 362 and the head 364. The stem 366 fixes the distance between the base 362 and the head 364. The stem 366 fixes the distance between the outer surface of the conductor and the inner surface of the channel. The stem 366 establishes the height of the channel (e.g., passage/channel 330 of FIG. 3). The stem 366 establishes the area around and along the length of the conductor through which the coolant moves.

In an example embodiment, two spacers 360 are positioned across the conductor opposite to each other. In another example embodiment, four spacers 360 are positioned around the conductor with the spacers 360 of one pair opposite each other and the spacers 360 of the other pair opposite each other. In an example embodiment, the base 362 is curved to fit along the inner surface of the channel. An example embodiment, the head 364 is curved to fit along the outer surface of the conductor. In an example embodiment, the depth (e.g., into page in FIG. 3) of the base 362, the head 364 and/or the stem 366 is between 0.5 cm and 5 cm. In another example embodiment, the depth of the base 362, the head 364 and/or the stem 366 is the length of the conductor. In other words, the spacers run along the entire length or nearly the entire length of the conductor. In an example embodiment, spacer pairs positioned opposite each other are positioned between 0 and 30 cm apart from each other along the length of the conductor. In an example embodiment, the height of the stem 366 is between 1 cm and 8 cm.

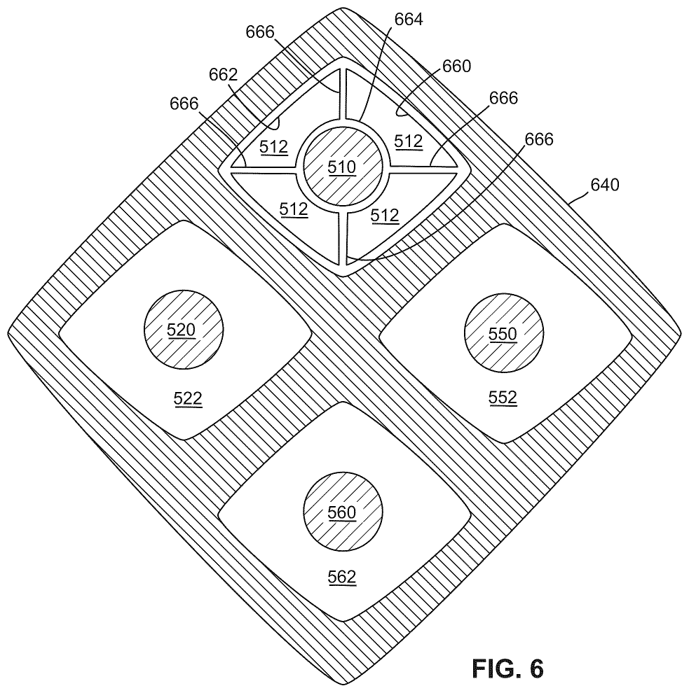

In another example embodiment, a spacer 660 includes an outer band 662, a plurality of standoffs 666 and an inner band 664. The outer band 662 contacts, is embedded in and/or is encircled by an inner surface of the channel (e.g., channel 512 as shown in FIG. 6). The inner band 664 encircles and/or is embedded in the conductor (e.g., conductor 510 as shown in FIG. 6). The plurality of standoffs 666 are positioned between the inner band 664 and the outer band 662. The plurality of standoffs 666 fix the distance between the outer band 662 and the inner band 664. The plurality of standoffs 666 fix the distance between the outer surface of the conductor and the inner surface of the channel. The plurality of standoffs 666 establish the height of the channel (e.g., channel 512 of FIG. 6). The plurality of standoffs 666 establish the area around and along the length of the conductor through which the coolant moves.

In an example embodiment, the outer band 662 is shaped to fit along the inner surface of the channel. The inner band 664 is shaped to fit along the outer surface of the conductor. In an example embodiment, the depth (e.g., into page in FIG. 6) of the outer band 662 and/or the inner band 664 is between 0.5 cm and 5 cm. In another example embodiment, the depth of the outer band 662, the inner band 664 and/or the standoffs 666 is the length of the conductor. In other words, the inner band 664 encircles the outer surface conductor along the entire length or almost the entire length of the conductor. The outer band 662 is positioned along the inner surface of the channel along the entire or almost the entire length of the channel. In an example embodiment, the height of each standoff of the plurality of standoffs 666 is between 1 cm and 8 cm.

In an example embodiment, the spacers 360/660 are formed of an electrically insulating material. In another example embodiment, the spacers 360/660 are formed of an electrically insulating, but thermally conductive material. In another example embodiment, the spacers 360/660 are formed of an electrically and thermally conductive material (e.g., metal). In the embodiments in which the spacers 360/660 are formed of thermally conductive material, the spacers 360/660 increase the thermal surface area of the conductor thereby increasing the amount of heat that can be transferred from the conductor into the coolant. For example, the surface area of the inner portion of the base 362 or the outer band 662 (e.g., the portion not in contact with the inner surface of the channel), the surface area of the stem 366 or standoff 666, and the surface area of the outer portion of the head 364 or inner band 664 (e.g., the portion not in contact with the conductor) come into contact with the coolant, thereby providing increased surface area for the transfer of heat from the conductor to the coolant. In this embodiment, the spacers 360/660 receive heat from the conductor. As the coolant passes over the conductor and the spacers 360/660, both the conductor and the spacers 360/660 transfer heat to the coolant, but because the spacers 360/660 increase the surface area of the conductors, the transfer of heat from the conductor and the spacers 360/660 to coolant is more effective than an embodiment that does not include the spacers 360/660.

### Evacuating Coolant from the Channels

As discussed above, after the process of charging the battery 240 of the electric vehicle 200 is completed, the liquid coolant is evacuated (e.g., removed) from the channels (e.g., 330, 340, 512, 522, 552, 562, 1110) of the electrical cable 140/540 or the pressure of a gaseous coolant in the channels (e.g., 330, 340, 512, 522, 552, 562, 1110) is reduced to make it easier for the user 230 to move the electrical cable 140/540.

Liquid coolant may be removed from the channels (e.g., 330, 340, 512, 522, 552, 562, 1110) of the electrical cable 140/540 in any manner. In describing example embodiments of methods for removing the coolant from the electrical cables 140/540, the term proximate end of the electrical cable 140/540 and/or the channels (e.g., 330, 340, 512, 522, 552, 562, 1110) refers to the portion of electrical cable 140/540 and/or the channels (e.g., 330, 340, 512, 522, 552, 562, 1110) proximate to the charger 100. The term distal end refers to the portion of electrical cable 140/540 and/or the channels (e.g., 330, 340, 512, 522, 552, 562, 1110) proximate to the handle 130/530 attached to the electrical cable 140/540.

In an example embodiment, the processing circuit is configured to control the components of the charger 100 to perform the following steps to evacuate the liquid coolant from the channels. Step (1): the coolant pump 740 ceases to pump the liquid coolant through the channels (e.g., 330, 340, 512, 522, 552, 562, 1110) of the electrical cable 140/540.

Step (2): the coolant pump 740 applies a vacuum force to the proximate end all of the chambers. In an example embodiment, the vacuum force is applied via the flow 748.

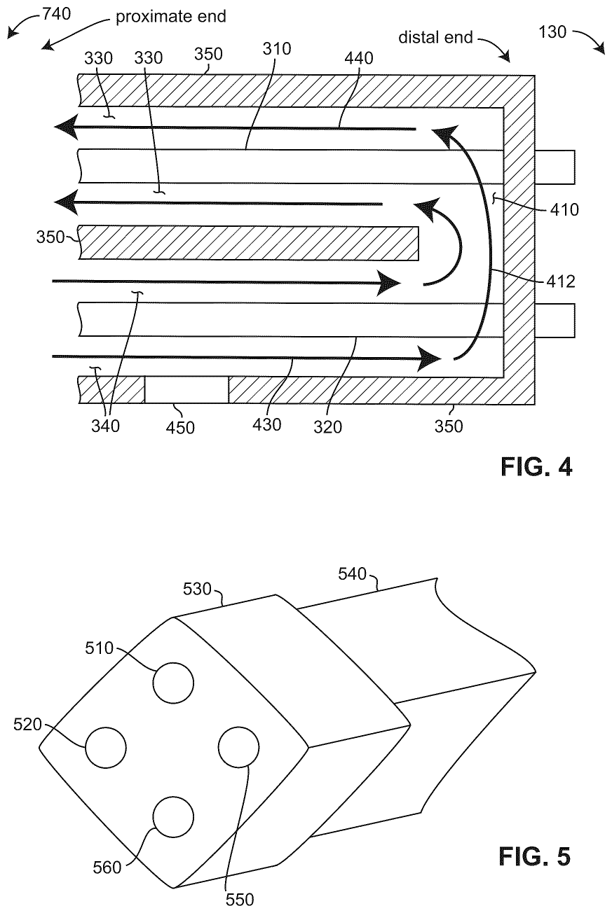

Step (3): the relief valve 450, positioned at any location along the length of the electrical cable 140/540 or at the handle 130/530 opens allowing air (e.g., a gas) into at least one of the channels. In FIG. 4, the relief valve 450 is shown positioned at the distal end of the electrical cable 140. In an example embodiment, the relief valve 450 is configured to open automatically upon application of the vacuum pressure to the channels. In another example embodiment, the relief valve 450 is an electromechanical device controlled by the processing circuit 710. The air flowing into the channels via the relief valve 450 enables the vacuum pressure applied by the coolant pump 740 to evacuate (e.g., suck, remove) most or all of the liquid coolant out of all of the chambers. The coolant pump 740 directs the coolant from the channels and any gas that may enter the coolant pump 740 into the coolant reservoir 746. The coolant pump 740 may remove any gas from the liquid prior to sending the liquid to the coolant reservoir 746. In another embodiment, the coolant pump 740 removes the gas from the liquid in the coolant reservoir 746.

Step (4): the coolant pump 740 stops supplying vacuum force to all of the channels. Step (5): the relief valve 450 closes, due to the change in pressure or by command of the processing circuit 710.

In another example embodiment, the processing circuit 710 is configured to control the components of the charger 100 to perform the following steps to evacuate the liquid coolant from the channels.

Step (1): the coolant pump 740 ceases to pump the liquid coolant through the channels (e.g., 330, 340, 512, 522, 552, 562, 1110) of the electrical cable 140/540.

Step (2): the coolant pump 740 pumps a gas (e.g., air) into at least one channel (e.g., inlet channel) of the electrical cable 140/540. The gas forces the liquid coolant out of the other channels (e.g., outlet channel). The coolant pump 740 receives the liquid coolant from other channels. The coolant pump 740 moves the liquid coolant into the coolant reservoir 746.

Step (3): once most or all of the liquid coolant is forced from the channels, the coolant pump 740 ceases to provide gas into the channel.

Step (4): The coolant pump 740 reduces the pressure of the gas in the channels. The coolant pump 740 reduces the pressure of the gas preferably to the pressure of a single atmosphere.

Step (5): The coolant pump 740 removes any gas from the liquid prior to sending the liquid to the coolant reservoir 746 or removes any gas from the liquid in the coolant reservoir 746.

In another example embodiment, the processing circuit 710 is configured to control the components of the charger 100 to perform the following steps to evacuate the phase change coolant from the channels.

Step (1): the coolant pump 740 ceases to pump the coolant that cools via phase change through the channels (e.g., 330, 340, 512, 522, 552, 562, 1110) of the electrical cable 140/540.

Step (2): the coolant pump 740 pumps a gas (e.g., coolant in gaseous form) into at least one channel (e.g., inlet channel) of the electrical cable 140/540. The gas forces the coolant that is in liquid form out of the other channels (e.g., outlet channel). The coolant pump 740 receives the coolant from other channels.

Step (3): once most or all of the coolant that is in liquid form is forced from the channels, the coolant pump 740 ceases to provide the gas into the channel. The coolant that is in gaseous form begins to cool and moves to its liquid state. The coolant that changes from the gas state to the liquid state inside the channels of the electrical cable 140/540 may leave a small amount of liquid in the channels. The small amount of liquid may be left in the channels if it does not impede the movement of the electrical cable 140/540 by the user 230. If the small amount of liquid left in the channels does impede movement of the electrical cable 140/540 by the user 230, it may be forced out of the channels as described above.

Step (4): The coolant pump 740 reduces the pressure of the gas in the channels. The coolant pump 740 reduces the pressure of the gas preferably to the pressure of a single atmosphere.

Step (5): the coolant cools and goes into its liquid state. The coolant pump 740 moves the liquid coolant into the coolant reservoir 746.

In another example embodiment, a small air compressor is positioned in the handle 130/530 at the distal end of the electrical cable 140/540. The air compressor is configured to be controlled by the processing circuit 710. The air compressor is configured to force pressurized air (e.g., high-pressure gas) into the distal ends of the channels. As the pressurized air enters the channels at the distal end, the coolant in the channels is pushed along the channels and out of the proximate ends into the coolant pump 740. The coolant pump 740 receives the coolant, whether in liquid or gas state until the channels are evacuated. Once the channels are evacuated, the processing circuit 710 is configured to stop the operation of the air compressor. The coolant pump 740 may direct the coolant to the coolant reservoir 746. The coolant pump 740 may remove any air injected into the coolant. The coolant pump may open and close the proximate ends of the channels to allow the air compressor to build up pressure inside the channels to better force the coolant from the channels into the coolant pump 740. The coolant pump 740 and/or the processing circuit 710 may open and close the proximate ends of the channels any number of times to better evacuate coolant from the channels. The coolant pump 740 may close the proximate ends other channels until the air compressor increases the pressure inside the channels to a threshold. Once a threshold is reached, the coolant pump 740 may open the proximate ends of the channels to allow the coolant to flow from the channels into the coolant pump 740 and/or the coolant reservoir 746.

In another example embodiment, the electrical cable 140/540 includes an additional channel (e.g., 1110) for transporting a high-pressure gas from the coolant pump 740 to the handle 130/530 and the distal ends of the channels (e.g., 330, 340, 512, 522, 552, 562). Additional channel is not used to carry coolant. The coolant pump 740 provides a high-pressure gas to the distal ends of the channels via the additional channel to force the coolant in the channels toward and into the coolant pump 740 and/or the coolant reservoir 746. The coolant pump 740 may very (e.g., increase, decrease, start, stop) the pressure of the additional channel to very the pressure inside the channels to better vacate the channels of coolant. Once the channels are vacated of coolant, the coolant pump 740 ceases to provide the high-pressure gas to the distal ends of the channels via the additional channel.

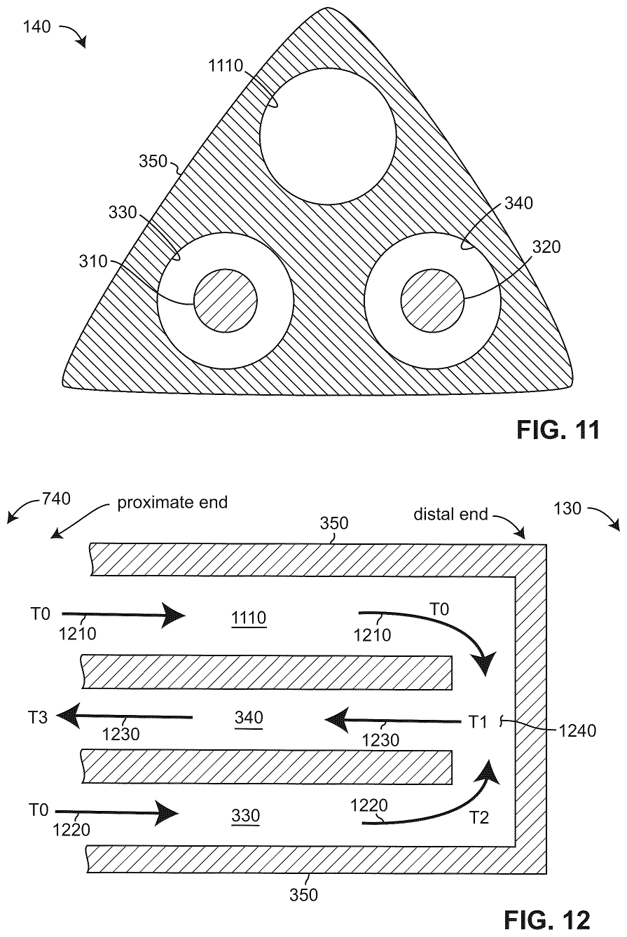

In another example embodiment, best seen in FIGS. 11-13, the electrical cable 140 includes an additional channel 1110. The additional channel 1110 does not surround a conductor. The additional channel 1110 may have the same diameter as channels 330 and 340 or it may be smaller. The additional channel 1110 may be used to transport coolant from the coolant pump 740 to the distal ends of the channels 330 and 340, which channels do surround conductors. Delivering coolant from the coolant pump 740 to the distal ends of the channels 330 and 340 via channel 1110 provides coolant at a chilled (e.g., cooled, low, TO) temperature to the distal end of the electrical cable 140. The advantage of providing chilled coolant to the distal end of the electrical cable 140 is that the coolant has not traveled along the length of a conductors and is not heated by the time it reaches the distal end of the electrical cable 140.

As best shown in FIG. 12, while battery 240 is being charged, coolant 1210 is pumped into channel 1110 and coolant 1220 is pumped into channel 330 both at temperature TO, which is the chilled temperature. When coolant 1210 reaches the chamber 1240 at the distal end of electrical cable 140, its temperature is still TO. When coolant 1220 reaches the chamber 1240, its temperature is T2, which is greater than T0, because it received (e.g., extracted) heat from conductor 310 along the way. The coolant 1210 and 1220 mix in chamber 1240 so that the temperature of the coolant flowing into the distal end of chamber 340 is temperature T1. Temperature T1 is less than temperature T2, but greater than temperature T0. By the time the coolant 1230 has traveled from the distal end to the proximate end of the electrical cable 140, its temperature has risen to be temperature T3. Temperature T3 is greater than temperature T2. Using channel 1110 to provide coolant at temperature T0 to the distal end of cable 140 decreases the temperature of the coolant entering channel 340 from the temperature T2 to the temperature T1 thereby providing additional cooling to the conductor 320 than it would otherwise have without using channel 1110. In another example embodiment, the temperature of coolant 1210 is less than the temperature T0 to reduce the temperature T1 entering the distal end of channel 340. However, the temperature T0 may be the lowest temperature at which the coolant pump may provide coolant, so the coolant 1210 and 1120 are the same at the proximate ends of the channels 1110 and 330.

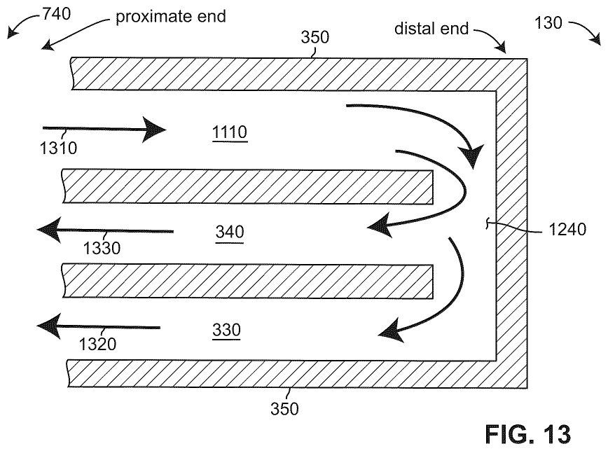

Once the battery 240 has been charged, the channel 1110, as best seen in FIG. 13, may be used to clear the coolant from the channels 330 and 340. To clear the coolant from the cable 140, the coolant pump 740 forces a pressurized gas 1310 into the proximate end of channel 1110. The pressurized gas 1310 pushes coolant from the proximate end to the distal end of channel 1110 into the chamber 1240. The pressurized gas forces the coolant out of chamber 1240 into the distal ends of channels 330 and 340. The pressurized gas forces the coolant 1320 and 1330 from the distal ends to the proximate ends of the channels 330 and 340 into the coolant pump 740 and/or the coolant reserve 746. Once the pressurized gas has pushed the coolant out of the electrical cable 140, the coolant pump 740 ceases to provide the high-pressure gas 1310.

In another example embodiment, the handle 130/530 may include a chamber. After the user has connected the electrical cable 140/540 to the electric vehicle 200, but before starting to charge the battery 240 of the electric vehicle 200, the coolant pump 740 forces gas into the chamber at a high pressure so that the chamber holds the gas at the high pressure. The coolant pump 740 may provide the high-pressure gas to the chamber via one or more of the channels (e.g., 330, 340, 512, 522, 552, 562) since at this point they do not contain coolant. Once the chamber contains the high-pressure gas, the coolant pump 740 and/or the processing circuit 710 closes a valve to the chamber thereby trapping the high-pressure gas inside the chamber. While the electric vehicle is being charged, the coolant flows through the channels and the chamber retains high-pressure gas. Once charging is completed, the valve to the chamber is opened so that the high-pressure gas pushes against the coolant in the channels at the distal ends of the channels. The high-pressure gas exits the chamber and pushes the coolant from the channels to the proximate end of the electrical cable 140/540. The high-pressure gas forces the coolant out of the channels (e.g., 330, 340, 512, 522, 552, 562) into the coolant pump 740 and/or the coolant reservoir 746 thereby evacuating the channels of coolant.

### First Example Method for Charging an Electric Vehicle

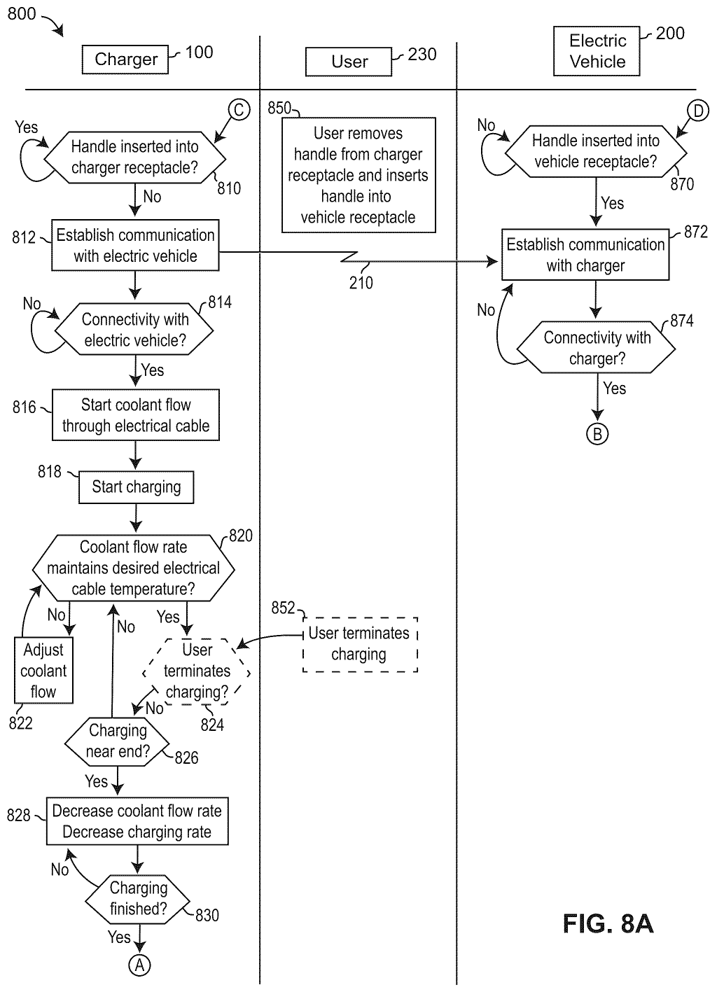

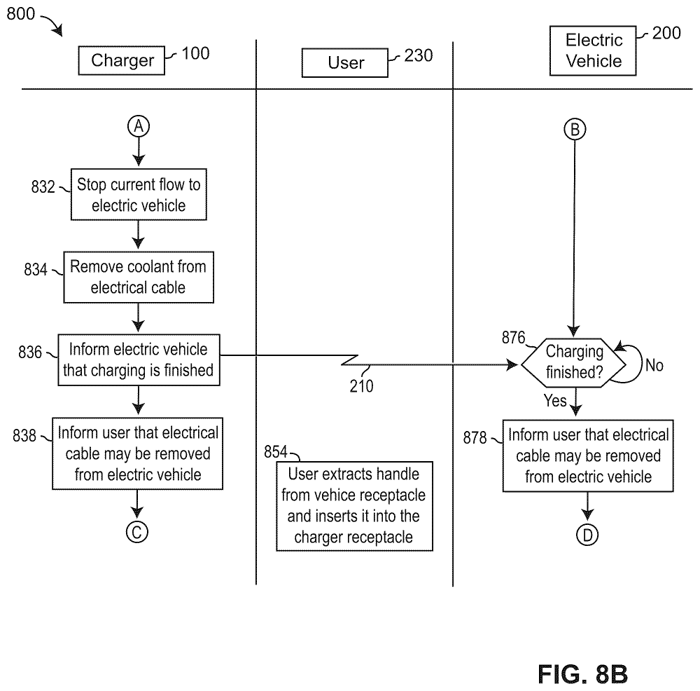

The method 800 is a first example method for charging a battery of an electric vehicle. Method 800 is performed by the charger 100, the user 230 and the electric vehicle 200. In the example method 800, the charger 100 is configured to perform the following operations: inserted 810, establish 812, connectivity 814, start 816, start 818, coolant 820, adjust 822, user 824, charging 826, decrease 828, finished 830, stop 832, remove 834, inform 836 and inform 838. The user 230 performs the following operations: removes 850, terminates 852 and extracts 854. The electric vehicle is configured to perform the following operations: handle 870, establish 872, connectivity 874, finished 876 and inform 878. The flow of the various operations of the example method 800 are shown in FIGS. 8A and 8B.

In inserted 810, the charger 100 determines whether the handle 130 is inserted into the receptacle 120. If the handle 130 is inserted into the receptacle 120, the charger is in a quiescent state in which it is not being used to charge the electric vehicle 200. If handle 130 is not inserted into the receptacle 120, the charger may presently be in use or will soon be in use to charge the battery 240 of the electric vehicle 200. Removal of handle 130 from the receptacle 120 causes operation of the charger 100 to move from inserted 810 to establish 812.

In establish 812, the charger 100 establishes communication with the electric vehicle 200 and/or the user 230 (e.g., user's electronic device) via the communication circuit 750. Establishing communication enables the charger 100 communicate with the electric vehicle 200 and/or the user 230 via the communication link 210.

In connectivity 814, the charger 100 determines whether the handle 130/530 and therefore the electrical cable 140/540 is electrically connected to the electric vehicle 200. If the handle 130/530 is electrically connected to the electric vehicle 200, the operation of the charger 100 moves to start 816.

In start 816, the processing circuit 710 is configured to instruct the coolant pump 740 to start the flow of coolant through the electrical cable 140. The operation start 816 moves the coolant from the coolant reservoir 746 into the channels (e.g., 330, 340, 512, 522, 552, 562, 1110).

In start 818, the processing circuit 710 is configured to instruct the power supply 730 to start providing electrical energy (e.g., a current) to the electric vehicle 200 via the electric cable 140 and the handle 130. The processing circuit 710 may wait to execute start 818 until the conductors (e.g., 310, 320, 510, 520, 550, 560) in the electrical cable 140/540 reach a threshold temperature.

In coolant 820, the processing circuit 710 is configured to monitor the pressure of the coolant and the flow of the coolant in coolant pump 740 and/or the electrical cable 140/540. The processing circuit 710 is further configured to monitor the temperature of the conductors (e.g., 310, 320, 510, 520, 550, 560) and/or the coolant. The operation coolant 820 may further compare the temperature of the coolant and/or the conductors to a desired temperature or a desired range of temperatures. If the temperature of the coolant and/or the conductors is not at or near the desired temperature or within the desired temperature range, operation may move to adjust 822. The execution of coolant 820 may be interrupted by the optional operation user 824. While the temperature of the conductors is monitored, the operation charging 826 may detect when the charging process is near its end.

In adjust 822, the processing circuit 710 is configured to adjust the pressure and/or the flow rate of the coolant in the electrical cable 140 to move the temperature of the conductors (e.g., 310, 320, 510, 520, 550, 560) to the desired temperature or to within the desired temperature range. For example, if the temperature of the conductors is higher than the desired temperature or range, the processing circuit 710 may increase the pressure and/or flow rate of the coolant to further cool the conductors. If the temperature of the conductors is lower than desired, the processing circuit 710 may decrease the pressure and/or flow rate of the coolant to allow the temperature of the conductors to increase.

User 824 is an optional operation. In user 824, the processing circuit 710 is configured to determine whether the user 230 has requested termination of the charging process. If the user has requested termination of the charging process, operation moves to decrease 828. If the user has not requested termination of the charging process, operation moves to charging 826.

In charging 826, the processing circuit 710 is configured to determine whether the charging process is near its end. The processing circuit 710 may communicate with the processing circuit 1010 to determine the status of the charging process. The processing circuit 1010 may monitor the voltage across battery 240 and/or the amount of charge stored by battery 240 to determine the status of the charging process. If the battery 240 is approaching the desired amount of energy to be stored, the processing circuit 1010 may inform the processing circuit 710 via the communication link 210 that charging is getting near to the end of the process. If charging is near the end of the process execution moves to decrease 828.

In decrease 828, the processing circuit 710 instructs the power supply 730 to decrease the charging rate or in other words the amount of energy being sent to the electric vehicle 200. In accordance with the temperature of the conductors, the processing circuit 710 may also instruct the coolant pump 740 to decrease the flow rate and/or pressure of the coolant in the electrical cable 140/540. Charging 826 and decrease 828 may be omitted so that control passes from user 824 or coolant 820 to finished 830.

Finish 830 determines whether the charging process is finished. During finish 830, the processing circuit 710 may further communicate with the processing circuit 1010 to receive additional information regarding charging from the electric vehicle 200. When the charging process is complete, execution moves to stop 832.

In stop 832, the processing circuit 710 is configured to instruct the power supply 732 stop supplying energy to the electric vehicle 200. In stop 832, the amount of current provided to the battery 240 via the electrical cable 140/540 is reduced to zero. The flow of coolant may continue for a period of time after the flow of current ceases to further cool the conductors (e.g., 310, 320, 510, 520, 550, 560). Operation remains in stop 832 until the conductors have reached a desired temperature or temperature range.

In remove 834, the processing circuit 710 is configured to instruct the coolant pump 740 to evacuate the coolant from the channels (e.g., 330, 340, 512, 522, 552, 562, 1110) of the electrical cable 140/540. The coolant pump 740 evacuates most if not all of the coolant from the electrical cable 140/540. Various example embodiments of methods for evacuating the coolant from the electrical cable 140/540 are discussed above.

In inform 836, the processing circuit 710 is configured to inform the user 230 via the display 150, the display 1062 and/or an electronic device (e.g., cell phone, tablet) that the charging process is complete.

In inform 838, the processing circuit 710 informs the user via the display 150, the display 1062 and/or an electronic device that the charging handle 130/530 may be removed from the receptacle 220. The processing circuit 710 may further request that the user insert the charging handle 130/530 into the receptacle 120.

In removes 850, the user removes the charging handle 130/530 from the receptacle 120. The user inserts the charging handle 130/530 into the receptacle 220. Six

Terminate 852 is an optional operation. In terminate 852, the user 230 requests termination of the charging process. Terminate 852 may be used to terminate the charging process prematurely. The user may request termination via the user interface 760 of the charger 100 and/or the user interface 1060 of the electric vehicle charging system 1000.

In extracts 854, the user extracts the handle 130 from the receptacle 220 and inserts the handle 130 into the receptacle 120. Because the coolant has been evacuated from the electrical cable 140/540 prior to performance of extracts 854, the electrical cable 140/540 is much lighter and more flexible than if it were filled with coolant, so the electrical cable 140/540 is much easier to handle than it otherwise would be.

In handle 870, the processing circuit 1010 is configured to determine whether the charging handle 130/530 is inserted into the receptacle 220. If the charging handle 130/530 is inserted into the receptacle 220, the charger 100 is or will soon be in an active state in which it is used to charge the battery 240. If charging handle 130/530 is not inserted into the receptacle 220, the charger cannot be used to charge the electric vehicle 200. Inserting the charging handle 130/530 into the receptacle 220 causes operation to move from handle 870 to establish 872.

In establish 872, the processing circuit 1010 establishes communication with the processing circuit 710 via the communication circuits 1050 and 750. Establishing communication enables the electric vehicle 200 to communicate with the charger 100 via the communication link 210.

In connectivity 874, the processing circuit 710 is configured to determine whether the charging handle 130/530 and therefore the electrical cable 140/540 is electrically connected to the electric vehicle 200. If the charging handle 130/530 is electrically connected to the electric vehicle 200, operation moves to finished 876.

Finish 876 determines whether the charging process is finished. Processing circuit 710 may cooperate with processing circuit 1010 to determine when the charging process is finished. The processing circuit 1010 may monitor the voltage across the battery 240 and/or the amount of charge stored by the battery 240. The processing circuit 710 may monitor the voltage across the conductors (e.g., 310, 320, 510, 520, 550, 560) and/or the amount of charge already provided to the battery 240. Either processing circuit 710, processing circuit 1010 or both may determine when charging the battery 240 is finished. The processing circuit 710 and 1010 may communicate with each other via the communication link 210 regarding the status of the charging process. When the charging process is complete, execution moves to inform 878.

In inform 878, the processing circuit 1010 informs the user 230 via the display 1062 and/or an electronic device that the electrical cable 140/540 may be removed from the receptacle 220.

### Second Example Method for Charging an Electric Vehicle

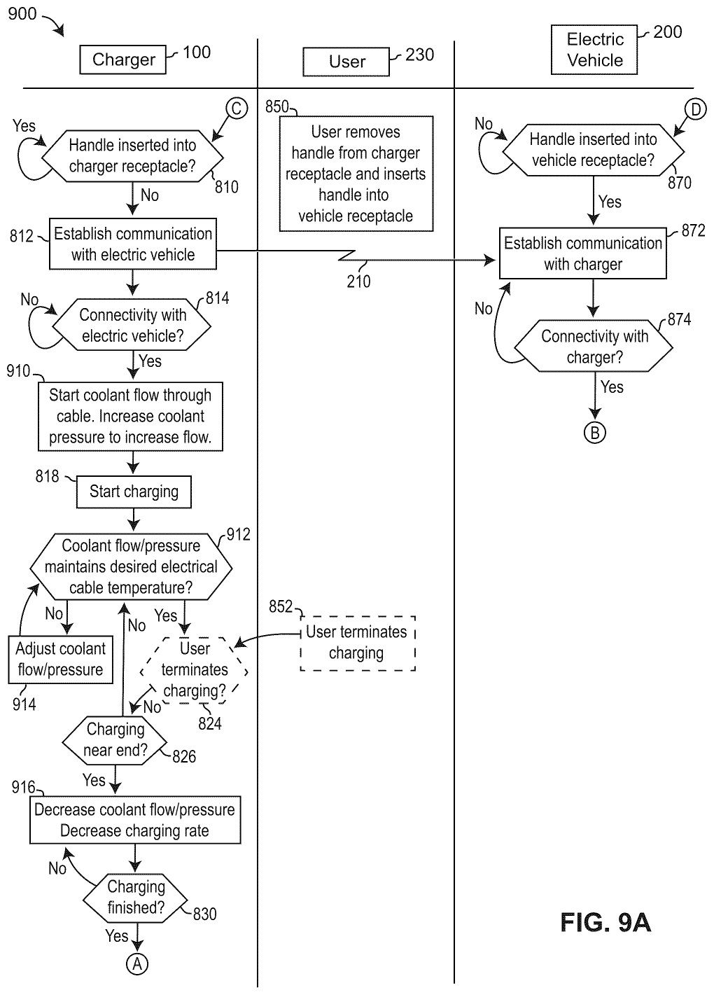

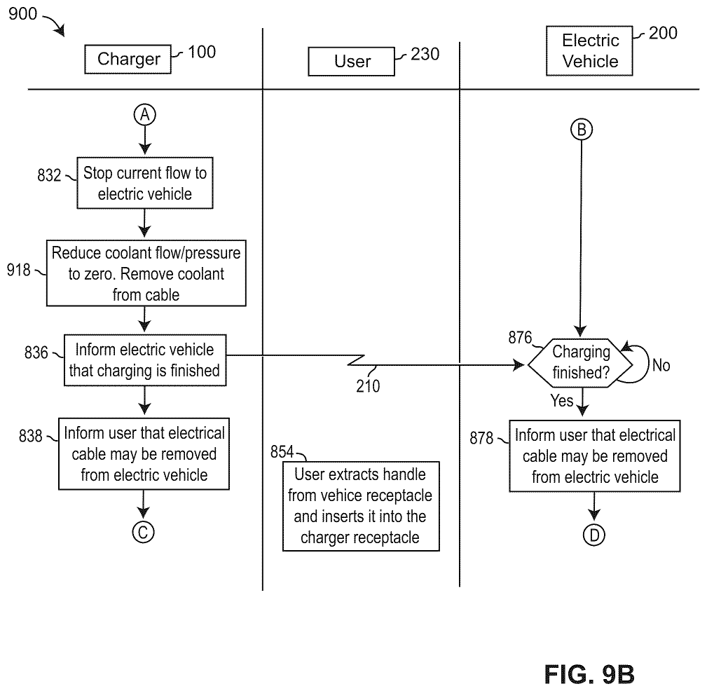

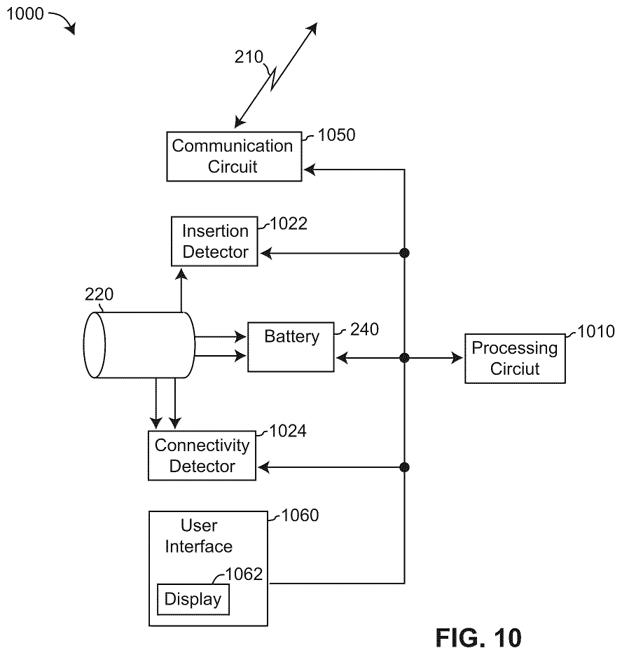

The method 900 is a second example method for charging a battery of an electric vehicle. The method 900 is performed by charger 100, user 230 and electric vehicle 200. In the method 900, the charger 100 is configured to perform the following operations: inserted 810, establish 812, connectivity 814, start 910, start 818, coolant 912, adjust 914, user 824, charging 826, decrease 916, finished 830, reduce 918, inform 836 and inform 838. The user 230 performs the following operations: removes 850, terminates 852 and extract 854. The electric vehicle is configured to perform the following operations: handle 870, establish 872, connectivity 874, finished 876 and inform 878. The flow of the various operations of the example method 900 are shown in FIGS. 9A and 9B.

The method 900 is for a coolant that changes phase to cool the conductors (e.g., 310, 320, 510, 520, 550, 560). Phase-change cooling uses the vaporization of a liquid to cool an object. A liquid may be injected into the channels (e.g., 330, 340, 512, 522, 552, 562, 1110) of the electrical cable 140/540. The heat from the conductors 310 and 320 causes the liquid to change from a liquid phase to a gas phase. The change in the phase of the liquid extracts heat from the conductors to cool them.

The operations inserted 810, establish 812, connectivity 814, start 818, user 824, charging 826, finished 830, inform 836, inform 838, removes 850, terminates 852, extract 854, handle 870, establish 872, connectivity 874, finished 876 and inform 878 of the method 900 are the same as the similarly number operations in the example method 800. The operations start 910, coolant 912, adjust 914, decrease 916 and reduce 918 of method 900 differ from the operations start 816, coolant 820, adjust 822, decrease 828 and remove 834 respectively of the method 800 in that method 900 deals with phase-change cooling whereas method 800 deals with cooling using a liquid that does not change phase.

In coolant 912, the processing circuit 710 is configured to change either the flow of the liquid into the electrical cable 140/540 or the pressure of the gas in the channels (e.g., 330, 340, 512, 522, 552, 562, 1110) to provide the cooling necessary to maintain the conductors (e.g., 310, 320, 510, 520, 550, 560) at a desired temperature or within a desired temperature range.

In adjust 914, the processing circuit 710 is configured to change either the flow of liquid coolant into the channels (e.g., 330, 340, 512, 522, 552, 562, 1110) of the electrical cable 140/540 or the pressure of the gas in the channels to either increase or decrease the amount of cooling performed to maintain the conductors at the desired temperature or within the desired temperature range.

In decrease 916, the processing circuit 710 is configured to change either the flow of the liquid coolant into the channels (e.g., 330, 340, 512, 522, 552, 562, 1110) of the electrical cable 140/540 and/or increases the extraction of gas from the channels to reduce the amount of coolant in the electrical cable 140/540.

In reduce 918, the processing circuit 710 is configured to control the coolant pump 740 to extract the coolant, regardless of phase, from the electrical cable 140/540 and/or to reduce the pressure of the gaseous coolant in the channels (e.g., 330, 340, 512, 522, 552, 562, 1110). The objective being to remove as much coolant as possible, regardless of phase, from the electrical cable 140/540.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process (e.g., step) of the embodiment be performed in the order presented. Words such as “thereafter,” “then,” “next,” etc. are not intended to limit the order of the processes, and these words are instead used to guide the reader through the description of the methods.

What is claimed is:

1. A charger for providing energy to a provided electric vehicle to charge a provided battery of the provided electric vehicle, the charger comprising:
a processing circuit;
a pump;
a power supply;
a coolant; and
an electrical cable, the electrical cable includes a first conductor, a second conductor, a first channel and a second channel, the first conductor positioned in the first channel, the second conductor positioned in the second channel; wherein:
the processing circuit is configured to detect an electrical connection between the first conductor, the second conductor and the provided electric vehicle;
responsive to detecting the electrical connection, the pump is configured to circulate the coolant through the first channel and the second channel to bring the coolant into contact with the first conductor and the second conductor to remove heat from the first conductor and the second conductor;
responsive to the pump circulating the coolant, the power supply is configured to provide energy through the first conductor and the second conductor to the provided battery;
the processing circuit is configured to detect when the provided battery is charged;
responsive to the processing circuit detecting that the provided battery is charged: (1) the power supply ceases to provide energy to the provided battery via the first conductor and the second conductor, and (2) the pump continues to circulate the coolant through the first channel and the second channel until a temperature of the first conductor and the second conductor reaches a threshold temperature; and
responsive to the first conductor and the second conductor reaching the desired temperature, the pump is configured to evacuate the coolant from the first channel and the second channel thereby reducing a weight of the electrical cable.

2. The charger of claim 1 wherein:
the electrical cable further includes a plurality of spacers;
the plurality of spacers are positioned along a length of the first conductor; and
the plurality of spacers establish a distance between an inner surface of the first channel and an outer surface of the first conductor to create a passage around the first conductor through which the coolant flows.

3. The charger of claim 2 wherein:
each spacer of the plurality of spacers is thermally conductive;
heat from the first conductor passes into the plurality of spacers; and
the coolant comes into contact with the first conductor and the plurality of spacers thereby removing heat from the first conductor and the plurality of spacers.

4. The charger of claim 2 wherein each spacer of the plurality of spacers comprises:
a base;
a head; and
a stem positioned between the base and the head; wherein:
the base contacts the inner surface of first channel;
the head contacts an outer surface of first conductor; and
the stem establishes the distance between the inner surface of the first channel and the outer surface of the first conductor.

5. The charger of claim 2 wherein each spacer of the plurality of spacers comprises:
an outer band;
an inner band; and
a plurality of standoffs positioned between the inner band and the outer band; wherein:
the inner surface of the first channel encircles and contacts the outer band;
the inner band encircles and contacts the outer surface of first conductor; and
the plurality of standoffs establish the distance between the inner surface of the first channel and the outer surface of the first conductor.

6. The charger of claim 1 wherein to evacuate the coolant from the first channel and the second channel, the pump is configured to:
apply a vacuum force to a proximate end of the first channel and the second channel;
open a relief valve positioned at or near a distal end of the first channel and the second channel to enable a gas to enter the distal end of the first channel and the second channel; and
evacuate the coolant from the first channel and the second channel via the proximate end of the first channel and the second channel.

7. The charger of claim 1 wherein to evacuate the coolant from the first channel and the second channel, the pump is configured to:
pump a gas into a proximate end of the first channel; and
receive the coolant via a proximate end of the second channel.

8. The charger of claim 1 wherein to evacuate the coolant from the first channel and the second channel, the pump is configured to:
evacuate the coolant that is in a liquid state from the first channel and the second channel; and
decrease a pressure of a gas that remains in the first channel and the second channel to at most one atmosphere.

9. The charger of claim 1 further the electrical cable comprising a third channel, the third channel separate from the first channel and the second channel, the third channel does not surround a conductor, wherein:
while charging the provided battery:
the pump pumps the coolant into a proximate end of the third channel; and
coolant from a distal end of the third channel mixes with coolant from a distal end of a first channel prior to entering a distal end of a second channel; and
while evacuating the coolant from the electrical cable:
the pump pumps a pressurized gas into the proximate end of the third channel; and
the pressurized gas forces the coolant via the distal end of the third channel and via a proximate end of the first channel and the second channel thereby evacuating the coolant from the first channel, the second channel and the third channel.

10. The charger of claim 1 wherein:
the electrical cable further includes a plurality of spacers;
the plurality of spacers are positioned along a length of the first channel and the second channel; and
the plurality of spacers establish a distance between an inner surface of the first channel and an outer surface of the first conductor, and between an inner surface of the second channel and an outer surface of the second conductor to create a first passage around the first conductor and a second passage around the second conductor through which the coolant flows.

11. A method for providing energy to an electric vehicle to charge a battery of the electric vehicle, the method comprising:
detecting an electrical connection between an electrical cable of a charger and the electric vehicle, the electrical cable includes a first conductor, a second conductor, a first channel and a second channel, the first conductor positioned inside the first channel and the second conductor positioned inside the second channel;
removing heat from the first conductor and the second conductor by pumping a coolant through the first channel and the second channel whereby the coolant comes into contact with the first conductor and the second conductor thereby extracting heat from the first conductor and the second conductor;
providing energy to the battery of the electric vehicle via the first conductor and the second conductor to charge the battery;
responsive to detecting that the battery is charged, stopping providing energy to the electric vehicle via the first conductor and the second conductor; and
removing the coolant from the first channel and the second channel thereby making it easier for a user to move or lift the electrical cable.

12. The method of claim 11 wherein removing heat from the first conductor and the second conductor comprises:
pumping the coolant into a proximate end the first channel, the coolant entering the first channel has a first temperature;
pumping the coolant along a length of the first channel and the second channel between an inner surface of the first channel and the second channel respectively and an outer surface of the first conductor and the second conductor respectively to bring the coolant into contact with the first conductor, the second conductor and a plurality of spacers that fix a distance between the inner surface of the first channel and the second channel and the outer surface of the first conductor and the second conductor respectively;
receiving the coolant from a proximate end of the second channel, the coolant exiting the proximate end of the second channel has a second temperature, the second temperature is greater than the first temperature; and
reducing a temperature of the coolant exiting the proximate end of the second channel from the second temperature to at most the first temperature prior to pumping the coolant back into the proximate end of the first channel.

13. The method of claim 11 wherein removing the coolant from the first channel and the second channel comprises:
applying a vacuum force to a proximate end of the first channel and the second channel;
opening a relief valve at or near a distal end of the first channel or the second channel to permit a gas to enter the distal end of first channel and the second channel; and
receiving the coolant from the first channel and the second channel via the proximate end of the first channel and the second channel.

14. The method of claim 11 wherein removing the coolant from the first channel and the second channel comprises:
applying a vacuum force to a proximate end of the first channel and the second channel;
releasing a high-pressure gas from a chamber into a distal end of the first channel and the second channel; and
receiving the coolant from the first channel and the second channel via the proximate end of the first channel and the second channel.

15. The method of claim 11 wherein removing the coolant from the first channel and the second channel comprises:
pumping a high-pressure gas into a proximate end of a third channel, the third channel separate from the first channel and the second channel, the third channel does not surround a conductor, a distal end of the third channel provides the high-pressure gas to a distal end of the first channel and the second channel; and
a high-pressure gas forces the coolant from the first channel, the second channel and the third channel via a proximate end of the first channel and the second channel.

16. The method of claim 11 wherein removing the coolant from the first channel and the second channel comprises:
releasing a pressurized gas from a chamber into a distal end of the first channel and the second channel; and
receiving the coolant from the first channel and the second channel via a proximate end of the first channel and the second channel.

17. A cable for providing energy to a provided electric vehicle to charge a provided battery of the provided electric vehicle, the cable comprising:
a housing having a first length and a channel along the first length, the channel having a first diameter and an inner surface;
a conductor having a second length, a second diameter and an outer surface, the second diameter less than the first diameter, the conductor positioned inside the channel along the first length, the second length greater than or equal to the first length; and
a plurality of spacers, the plurality of spacers positioned around the conductor along the first length of the channel, each spacer of the plurality of spacers contacts the inner surface of the channel and the outer surface of the conductor to establish a distance between the inner surface of the channel and the outer surface of the conductor, the plurality of spacers maintain the channel open around the conductor for a flow of a provided coolant, whereby the flow of the provided coolant contacts the outer surface of the conductor whereby heat is transferred from the conductor to the provided coolant at a first rate to reduce a temperature of the conductor.

18. The cable of claim 17 wherein:
the plurality of spacers are formed of a thermally conductive material;
contact between the outer surface of the conductor and the plurality of spacers transfers heat from the conductor to the plurality of spacers; and
the flow of the provided coolant contacts the plurality of spacers and the outer surface of the conductor whereby heat is transferred from the plurality of spacers and the conductor at a second rate, the second rate is greater than the first rate.

19. The cable of claim 18 wherein prior to handling of the cable by a user, a provided pump evacuates the provided coolant from the channel thereby reducing a weight of the cable.
